(19) United States
(12) Patent Application Publication
(10) Pub. No.: US 2019/0268937 A1
(43) Pub. Date: Aug. 29, 2019

(54) WIRELESS SYSTEM AND WIRELESS APPARATUS

(71) Applicants: Kabushiki Kaisha Toshiba, Tokyo (JP); Toshiba Electronic Devices & Storage Corporation, Tokyo (JP)

(72) Inventor: Katsuya Nonin, Kawasaki Kanagawa (JP)

(21) Appl. No.: 16/122,374

(22) Filed: Sep. 5, 2018

(30) Foreign Application Priority Data
Feb. 26, 2018 (JP) 2018-031651

(51) Int. Cl. H04W 74/08; H04W 72/04; H04L 25/02

(52) U.S. Cl. CPC H04W 74/0808; H04L 25/0204; H04W 72/0453

(57) ABSTRACT

A wireless system of an embodiment includes two wireless apparatuses. Each wireless apparatus includes: a reception circuit configured to receive a signal in a predetermined frequency band; a carrier sensing circuit configured to perform carrier sensing in which, in response to reception of a predetermined signal, signals on a plurality of channels included in the predetermined frequency band are simultaneously received, and use states of the respective channels are detected based on the received signals on the respective channels; and an idle channel determiner configured to determine an idle channel from the plurality of channels based on the use states of the respective channels detected in the carrier sensing circuit according to a predetermined determination rule.

### CROSS-REFERENCE TO RELATED APPLICATION

This application is based upon and claims the benefit of priority from the prior Japanese Patent Application No. 2018-031651 filed in Japan on Feb. 26, 2018; the entire contents of which are incorporated herein by reference.

### FIELD

An embodiment described herein relates generally to a wireless system and a wireless apparatus.

### BACKGROUND

It may be required for a wireless apparatus to perform carrier sensing for checking whether a channel to be used for transmission is idle before transmitting a wireless signal.

The carrier sensing is to check whether a channel to be used is in a busy state, that is, whether the channel is in use. When the channel is in the busy state as a result of the carrier sensing, the wireless apparatus waits for the channel to enter an idle state, that is, waits for the channel to become unused, and then transmits a wireless signal.

When a plurality of channels are available, the wireless apparatus searches for an idle channel from within the plurality of channels in a predetermined order. For example, when a certain channel is in the busy state, a wireless apparatus on a transmission side will communicate information on another channel to be subjected to carrier sensing to a wireless apparatus on a reception side using a wireless signal in another frequency band. And then the wireless apparatus on the transmission side performs carrier sensing of the communicated channel. If this communicated channel is also in the busy state, the wireless apparatus on the transmission side will communicate yet another channel to be subjected to carrier sensing to the wireless apparatus on the reception side, then performs carrier sensing of the yet another communicated channel, and so on. Thus searching for an idle channel while checking whether a plurality of channels are in the busy state one by one in order.

However, when many channels are in the busy state even if a plurality of available channels exist, there will be a problem that determination of an idle channel is delayed, and as a result start of transmission of a wireless signal is delayed.

### BRIEF DESCRIPTION OF THE DRAWINGS

FIG. 1 is a configuration diagram of a wireless system according to an embodiment;

FIG. 2 is a diagram, showing a sequence of carrier sensing and signal transmission/reception in the wireless system according to the embodiment;

FIG. 3 is a block diagram showing a circuit configuration of a, wireless apparatus according to the embodiment;

FIG. 4 is a block diagram showing a circuit configuration of the wireless apparatus according to the embodiment;

FIG. 5 is a diagram for explaining a determination rule of an idle channel using carrier sensing in each wireless apparatus according to the embodiment;

FIG. 6 is a diagram for explaining a determination rule of an idle channel using earlier sensing in, a wireless apparatus on a reception side according to the embodiment;

FIG. 7 is a diagram showing a frequency band in carrier sensing in the wireless apparatuses according to the embodiment;

FIG. 8 is a diagram showing a frequency band in signal demodulation in the wireless apparatuses according to the embodiment; and

FIG. 9 is a diagram for explaining a, determination rule in carrier sensing in each wireless apparatus when a plurality of blocks each having a plurality of channels exist, according to the embodiment.

### DETAILED DESCRIPTION

A wireless system of an embodiment is a wireless system including a first wireless apparatus and a second wireless apparatus, in which the first wireless apparatus includes: a first reception circuit configured to receive a signal in a predetermined frequency band; a first carrier sensing circuit configured to perform first carrier sensing in which, in response to reception of a first signal, signals on a plurality of channels included in the predetermined frequency band received in the first reception circuit are simultaneously received and use states of the respective channels are detected based on the received signals on the respective channels; and a first idle channel determiner configured to determine an idle channel from the plurality of channels based on the use states of the respective channels detected in the first carrier sensing circuit according to a predetermined determination rule, and the second wireless apparatus includes: a second reception circuit configured to receive a signal in the predetermined frequency band; a second carrier sensing circuit configured to perform second carrier sensing in which, in response to reception of a second signal, signals on the plurality of channels included in the predetermined frequency band received in the second reception circuit are simultaneously received and the use states of the respective channels are detected based on the received signals on the respective channels; and a second idle channel determiner configured to determine the idle channel from the plurality of channels based on the use states of the respective channels detected in the second carrier sensing circuit according to a same determination rule as the predetermined determination rule.

The embodiment will be described below with reference to the drawings.

### (Configuration)

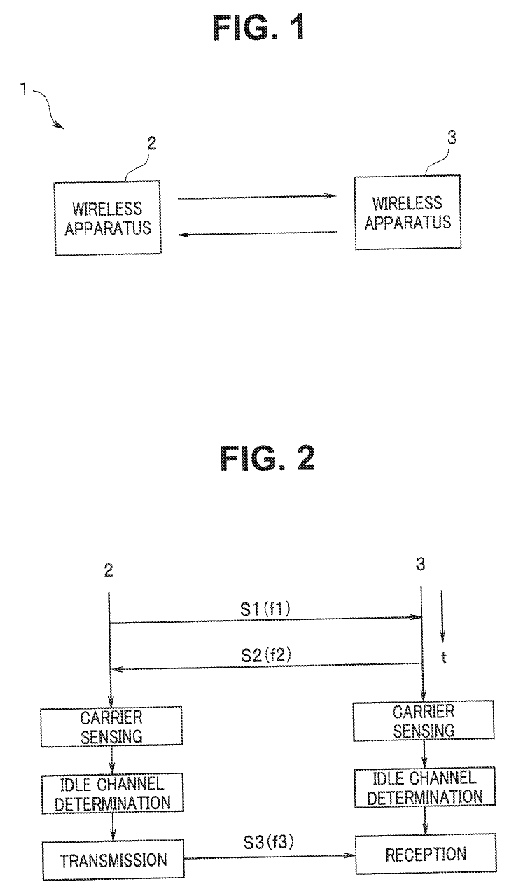

FIG. 1 is a configuration diagram of a wireless system according to the embodiment. FIG. 2 is a diagram showing a sequence of carrier sensing and signal transmission/reception in a wireless system 1.

The wireless system 1 includes a first wireless apparatus 2 and a second wireless apparatus 3. The wireless apparatus 2 and the wireless apparatus 3 can transmit/receive a signal with each other wirelessly.

FIG. 2 shows a sequence of carrier sensing and signal transmission/reception in accordance with a lapse of time t when the wireless apparatus 2 has a signal to be transmitted. For example, when the wireless apparatus 2 has data to be transmitted, the wireless apparatus 2 transmits a wireless signal S1 in a predetermined frequency band f1 as shown in FIG. 2. The frequency band 11 of the wireless signal S1 is a frequency band in which carrier sensing is not legally required.

When receiving the wireless signal S1, the wireless apparatus 3 transmits a wireless signal S2 in a predetermined frequency band 12 different from the frequency band f1. The wireless signal S1 and the wireless signal S2 are signals in frequency bands different from each other. The wireless signal S2 is a response signal to reception of the wireless signal S1. The frequency band t2 of the wireless signal S2 is different from the frequency band f1, and is a frequency band in which carrier sensing is not legally required.

The wireless apparatus 3 executes carrier sensing described later in response to reception of the wireless signal S1, that is, by using reception of the wireless signal S1 as a trigger.

The wireless apparatus 2 executes carrier sensing described later in response to reception of the wireless signal S2, that is, by using reception of the wireless signal S2 as a trigger.

In each of the wireless apparatuses 2 and 3, an idle channel is determined after carrier sensing. When an idle channel is determined, the wireless apparatus 2 transmits a signal using the idle channel, and the wireless apparatus 3 receives the signal using the idle channel.

Carrier sensing performed in the wireless apparatuses 2 and 3 is simultaneously performed for a plurality of channels included in a predetermined frequency band 13 used to transmit/receive a signal between the wireless apparatus 2 and the wireless apparatus 3. The predetermined frequency hand 13 used to transmit/receive a signal between the wireless apparatus 2 and the wireless apparatus 3 is a frequency hand in which carrier sensing is legally required.

The predetermined frequency band f3 is different from the frequency band f1 of the wireless signal S1 and the frequency band f2 of the wireless signal S2.

The frequency band f1 is a frequency band in which carrier sensing is not legally required, for example, a frequency band being a 120-135 KHz band in Japan.

The frequency band f2 is also a frequency band in which carrier sensing is not legally required, for example, a frequency band being a 315-433 MHz band in Japan.

Conversely, the frequency band 13 is a frequency band in which carrier sensing is legally required, for example, a frequency band being a 920 MHz band in Japan. Note that although a signal propagation distance of the wireless signal S2 is assumed to be relatively larger than signal propagation distances of the wireless signals S1 and S3 in the description of the embodiment, the distances are not necessarily limited to the assumption, and the relationship among the signal propagation distances may change depending on transmission power, reception ability, or the like.

Thus, by using the wireless signals S1, S2, and S3 in different frequency bands, it is possible to transmit/receive signals between the wireless apparatuses 2 and 3 when a distance between the wireless apparatuses 2 and 3 is within a predetermined distance range.

The frequency bands described above are illustrative. Available frequency bands are selected according to a law of each country or each region.

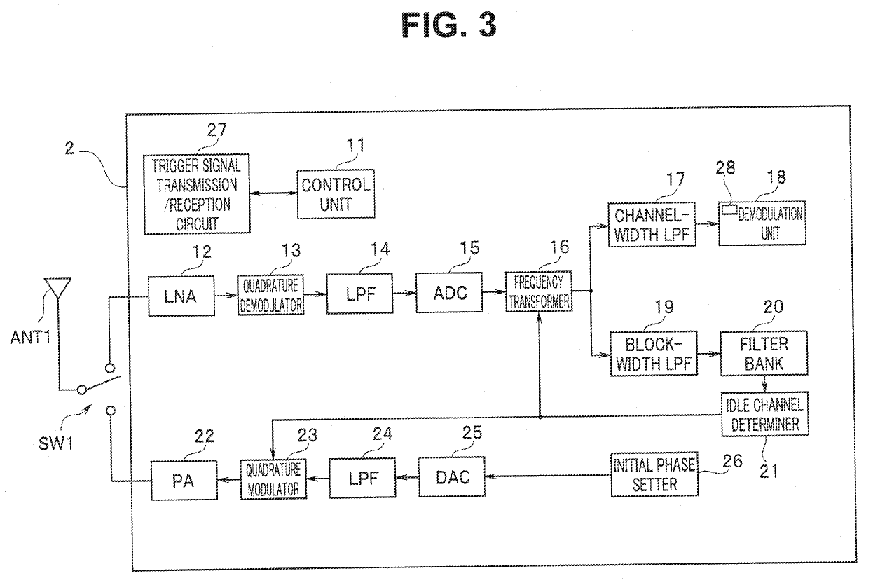

FIG. 3 is a block diagram showing a circuit configuration of the wireless apparatus 2.

The wireless apparatus 2 has an antenna ANT1 for communication, and a switch SW1 for switching transmission/reception.

Furthermore, the wireless apparatus 2 includes a control unit 11, a low noise amplifier (hereinafter called an LNA) 12, a quadrature demodulator 13, a low pass filter (hereinafter called an LPF) 14, an analog-to-digital converter (hereinafter called an ADC) 15, a frequency transformer 16, a channel-width low pass filter (hereinafter called a channel-width LPF) 17, a demodulation unit 18, a block-width low pass filter (hereinafter called a block-width LPF) 19, a filter bank 20, an idle channel determiner 21 as a circuit, a power amplifier (hereinafter called a PA) 22, a quadrature modulator 23, an LPF 24, a digital-to-analog converter (hereinafter called a DAC) 25, an initial phase setter 26, and a trigger signal transmission/reception circuit 27. The demodulation unit 18 includes a signal confirmation unit 28. Each unit of the wireless apparatus 2 is composed of a hardware circuit here.

The control unit 11 includes a circuit configured to control overall operation of the wireless apparatus 2. Although the control unit 11 is composed of a hardware circuit, the control unit 11 may be composed of a central processing unit (CPU) capable of executing a control program (or software). The control unit 11 receives an output signal or a state signal of each unit in the wireless apparatus 2, and also outputs a control signal to each unit to control operation of each unit.

Under control of the control unit 11, the switch SW1 is switched to connect the antenna ANT1 to the LNA 12 in a state where the wireless apparatus 2 receives the wireless signal S3 in the frequency band f3, and to connect the antenna ANT1 to the PA 22 in a state where the wireless apparatus 2 transmits the wireless signal S3 in the frequency band f3.

The signal received by the antenna ANT1 is amplified in the LNA 12, and then converted in the quadrature demodulator 13 into an I signal being an in-phase component with respect to a fundamental wave and a Q signal being a quadrature component.

An output of the quadrature demodulator 13 has noise or the like removed in the LPF 14, and is inputted to the ADC 15. A signal digitized in the ADC 15 is inputted to the frequency transformer 16, and is transformed into a frequency of a baseband signal.

The frequency transformer 16 is a circuit configured to transform a frequency of a received signal into the frequency of a baseband signal. As describe later, the frequency transformer 16 transforms a signal with a frequency corresponding to a band with a block width, which is a width of 1 MHz here, into the frequency of a baseband signal in carrier sensing, and transforms a signal with a frequency of an idle channel determined in the idle channel determiner 21 into a baseband signal in signal demodulation.

The LNA 12, the quadrature demodulator 13, the LPF 14, the ADC 15, and the frequency transformer 16 compose a reception circuit configured to receive a signal in a predetermined frequency band (1 MHz).

An output signal of the frequency transformer 16 is supplied to the channel-width LPF 17 and the block-width LPF 19.

The channel-width LPF 17 filters only a signal in a channel width for supply to the demodulation unit 18.

For example, when a signal is a signal in a range of 200 KHz, only the signal is outputted to the demodulation unit 18.

The demodulation unit 18 has various functions, and executes a predetermined process on a received signal.

The output signal of the frequency transformer 16 is also inputted to the block-width LPF 19, and is supplied to the filter bank 20.

The block-width LPF 19 outputs a signal in a predetermined width, which is a width of 1 MHz here, to the filter bank 20.

The signal supplied to the filter bank 20 is a signal in the frequency band f1 including a plurality of channels used to transmit/receive the wireless signal S3.

For example, when a range of 1 MHz from 920 MHz to 921 MHz is used as one block and five channels are set in the block, the block-width LPF 19 performs filtering so as to pass only signals in the range of 1 MHz for output to the filter bank 20.

The filter bank 20 is an array of bandpass filters configured to pass only signals with a plurality of predetermined frequencies.

Each signal from the filter bank 20 is supplied to the idle channel determiner 21. An output of the filter bank 20 is a signal on one or two or more channels in the busy state. For example, when the five channels described above exist and first and third channels are in the busy state, signals on the first and third channels are outputted, and signals on second, fourth, and fifth channels are not outputted.

Note that instead of the filter bank 20, FFT (fast Fourier transformer) may be used to detect whether frequencies of the five channels exist or not.

The idle channel determiner 21 detects power of a signal on each channel from the filter bank 20, and determines that a channel, power of which is detected, is a channel in the busy state, and that a channel, power of which is not detected, is a channel in the idle state.

A procedure for determining an idle channel from among a plurality of channels in the idle state in the idle channel determiner 21 will be described later. The idle channel determiner 21 supplies data or a signal regarding the determined idle channel to the frequency transformer 16 and the quadrature modulator 23.

A signal to be transmitted in the wireless apparatus 2 is converted in the DAC 25 into an analog signal, and is supplied to the LPF 24. The signal to be transmitted filtered in the LPF 24 is outputted through the quadrature modulator 23 from the PA 22, and is transmitted from the antenna ANT1 as the wireless signal S3.

The DAC 25 is given initial phase data outputted from the initial phase setter 26. Here, the wireless signal S3 is an unmodulated continuous wave, an initial phase of which is settable. The initial phase data of the wireless signal S3 is set in the initial phase setter 26. The PA 22, the quadrature modulator 23, the LPF 24, and the DAC 25 compose a transmission circuit configured to transmit the signal to be transmitted (S3) using the idle channel determined in the idle channel determiner 21.

The trigger signal transmission/reception circuit 27 includes a circuit for transmission of the wireless signal S1 in FIG. 2, and a circuit and an antenna for reception of the wireless signal S2 under control of the control unit 11.

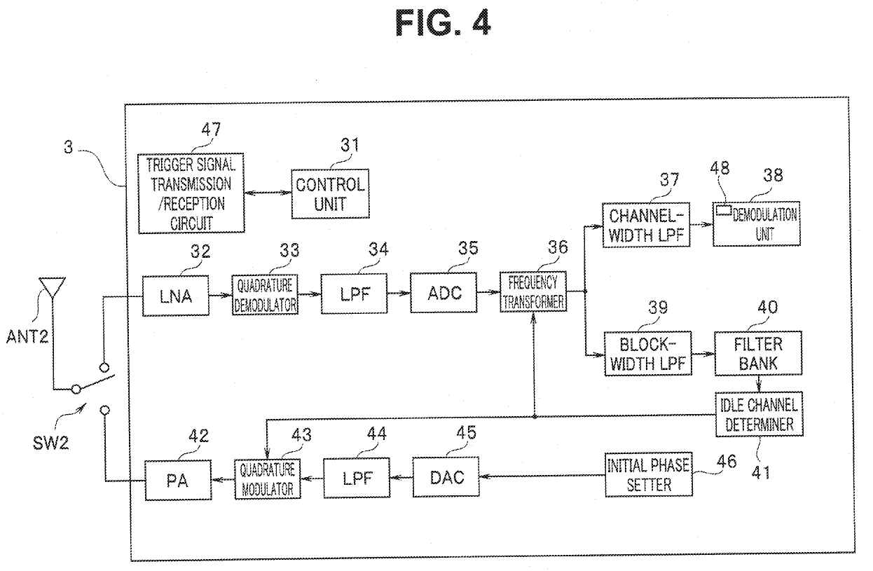

FIG. 4 is a block diagram showing a circuit configuration of the wireless apparatus 3. The circuit configuration of the wireless apparatus 3 is the same as the circuit configuration of the wireless apparatus 2 as shown in FIG. 4.

An antenna ANT2 and a switch SW2 in the wireless apparatus 3 correspond to the antenna ANT1 and the switch SW1 in the wireless apparatus 2.

A control unit 31, an LNA 32, a quadrature demodulator 33, an LPF 34, an ADC 35, a frequency transformer 36, a channel-width low pass filter 37, a demodulation unit 38, a block-width LPF 39, a filter bank 40, an idle channel determiner 41 as a circuit, a PA 42, a quadrature modulator 43, an LPF 44, a DAC 45, an initial phase setter 46, a trigger signal transmission/reception circuit 47, and a signal confirmation unit 48 in the wireless apparatus 3 correspond to the control unit 11, the LNA 12, the quadrature demodulator 13, the LPF 14, the ADC 15, the frequency transformer 16, the channel-width low pass filter 17, the demodulation unit 18, the block-width LPF 19, the filter bank 20, the idle channel determiner 21, the PA 22, the quadrature modulator 23, the LPF 24, the DAC 25, the initial phase setter 26, the trigger signal transmission/reception circuit 27, and the signal confirmation unit 28 in the wireless apparatus 2, respectively.

A configuration of each unit in the wireless apparatus 3 is the same as the configuration of each unit in the wireless apparatus 2.

The LNA 32, the quadrature demodulator 33, the LPF 34, the ADC 35, and the frequency transformer 36 compose a reception circuit configured to receive a signal in a predetermined frequency band (1 MHz).

The PA 42, the quadrature modulator 43, the LPF 44, and the DAC 45 compose a transmission unit configured to transmit a signal to be transmitted using an idle channel determined in the idle channel determiner 41.

As shown in FIG. 2, when having the wireless signal S3 being a signal to be transmitted, the wireless apparatus 2 first transmits the wireless signal S1 using the trigger signal transmission/reception circuit 27.

Therefore, at first, the control unit 11 of the wireless apparatus 2 controls the trigger signal transmission/reception circuit 27 to transmit the wireless signal S1.

When receiving the wireless signal S1, the control unit 31 of the wireless apparatus 3 performs carrier sensing described later using the wireless signal S1 as a trigger signal.

When receiving the wireless signal S2, the control unit 11 of the wireless apparatus 2 performs carrier sensing described later using the wireless signal S2 as a trigger signal.

An example of a determination rule of an idle channel in the idle channel determiners 21 and 41 will be described here.

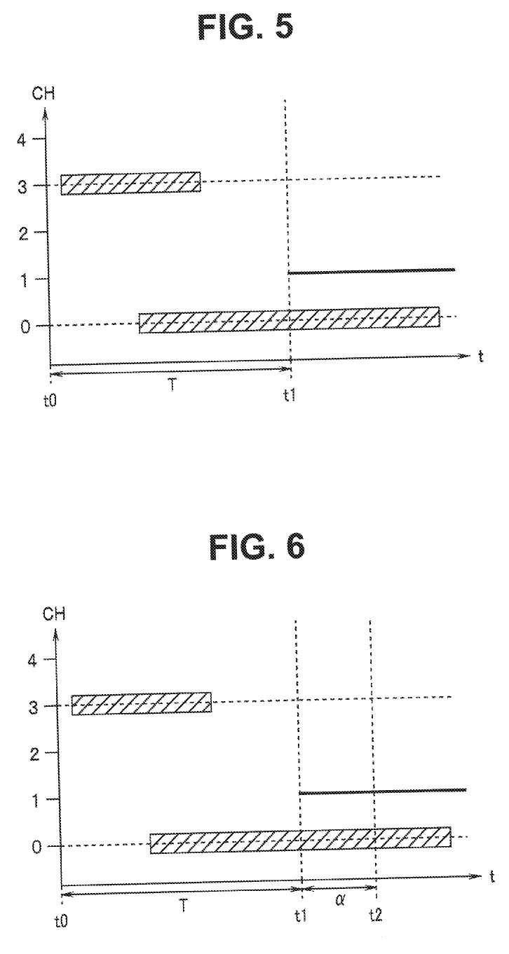

FIG. 5 is a diagram for explaining a determination rule of an idle channel using carrier sensing in each of the wireless apparatuses 2 and 3. The idle channel determiners 21 and 41 determine an idle channel based on a same determination rule. First, a rule in the idle channel determiner 21 of the wireless apparatus 2 will be described.

The idle channel determiner 21 has a circuit configured to detect and monitor power of each output signal from the filter bank 20. An idle channel is determined from the detected power based on a predetermined rule.

FIG. 5 shows that in a predetermined time period T from timing t0 of reception of the wireless signal S1 being a trigger signal to timing t1, a channel 0 and a channel 3 have experienced the busy state, and channels 1, 2, and 4 have been in the idle state. FIG. 5 shows that a time period shown by hatched lines is busy.

Here, if the determination rule of an idle channel is a rule on which a channel with a smallest number is determined as an idle channel when a plurality of channels in the idle state exist, the idle channel determiner 21 determines the channel 1 as an idle channel. In FIG. 5, the thick line shows that the channel 1 is determined as an idle channel.

When an idle channel is determined, data on the determined idle channel is supplied to the frequency transformer 16 and the quadrature modulator 23. The frequency transformer 16 transforms a signal from the ADC 15 into a baseband signal using the frequency of the determined idle channel. The signal to be transmitted is quadrature-modulated using the frequency band of the idle channel determined in the quadrature modulator 23, which is the channel 1 in the above example, and is transmitted.

Thus, the transmission circuit composed of the PA 22, the quadrature modulator 23, the LPF 24, and the DAC 25 transmits the signal (S3) using the idle channel determined in the idle channel determiner 21.

Note that in the demodulation unit 18, after the predetermined time period T has elapsed, various processes can be executed according to signals from the wireless apparatus 3 using the idle channel.

When receiving the wireless signal S1 being a trigger signal, also the wireless apparatus 3 being the reception side performs carrier sensing. Similar determination to the idle channel determiner 21 of the wireless apparatus 2 is performed, and data on the determined idle channel is supplied to the frequency transformer 36 and the quadrature modulator 43. An output of the frequency transformer 36 is supplied through the channel-width LPF 37 to the demodulation unit 18.

Therefore, the wireless apparatuses 2 and 3 can receive the wireless signal S3 in the reception circuits including the frequency transformers 16 and 36 using the idle channel determined in the idle channel determiners 21 and 41. The reception circuits including the frequency transformers 16 and 36 receive the wireless signal S3 by using a signal in the frequency band of the idle channel for demodulation and transformation into a baseband signal.

Each of the filter banks 20 and 40 composes a carrier sensing circuit configured to perform carrier sensing in which in response to reception of the predetermined signal S1 or S2, signals on a plurality of channels included in the predetermined frequency band (1 MHz) received in the reception circuit including the quadrature demodulator 13 or 33 and the like are simultaneously received, and a use state of each channel is detected based on the received signal on each channel.

Each of the idle channel determiners 21 and 41 determines an idle channel for transmitting or receiving a signal from a plurality of channels based on the use state of each channel detected in the carrier sensing circuit according to the predetermined determination rule.

Note that the wireless apparatus 3 on the reception side confirms a signal and then demodulates the signal.

FIG. 6 is a diagram for explaining a determination rule of an idle channel using carrier sensing in the wireless apparatus 3 on the reception side. As shown in FIG. 6, in the wireless apparatus 3 on the reception side, after timing t2 by which the predetermined time period T has elapsed and then a time period a for the confirmation process has further elapsed, demodulation is performed in the demodulation unit 38 for use in a predetermined process. FIG. 6 also shows that a time period shown by hatched lines is busy.

For example, when a process based on an unmodulated signal is performed, an erroneous process may be executed if demodulation and the process are executed without confirming that a predetermined unmodulated signal has been received successfully. So, here, in order to execute the predetermined process after confirming that the predetermined unmodulated signal has been received successfully, the predetermined process is executed in the demodulation unit 38 after it has been confirmed that a signal received in the signal confirmation unit 48 of the demodulation unit 38 is the predetermined unmodulated signal, that is, after the timing t2.

As described above, for example, when five channels are set as the predetermined frequency band f3 between 924 MHz and 925 MHz at an interval of 200 KHz with five center frequencies, the wireless apparatuses 2 and 3 perform communication using the wireless signal S3 with a center frequency as f3 which is selected and determined based on the predetermined rule from among the five channels.

### (Operation)

Next, operation of the wireless system 1 described above will be described. A case will be described below where the wireless apparatus 2 has a signal to be transmitted, and the wireless apparatus 3 receives the signal.

When the wireless apparatus 2 on the transmission side has a signal to be transmitted to the wireless apparatus 3, the control unit 11 of the wireless apparatus 2 controls the trigger signal transmission/reception circuit 27 to transmit the wireless signal S1.

When the wireless apparatus 3 on the reception side receives the wireless signal S1 in the trigger signal transmission/reception circuit 47, the control unit 31 controls the trigger signal transmission/reception circuit 47 to transmit the wireless signal S2, and also starts carrier sensing.

When the wireless apparatus 2 receives the wireless signal S2 in the trigger signal transmission/reception circuit 27, the control unit 11 starts carrier sensing.

The control unit 11 of the wireless apparatus 2 controls the switch SW1 to connect the antenna ANT1 and the LNA 12 to enable reception of the wireless signal S3.

For example, when a range from 920 MHz to 921 MHz is used as one block and five channels are set in the block, the frequency transformer 16 transforms a frequency of a signal in a range of 1 MHz into the frequency of a baseband signal, and the block-width LPF 19 passes only a signal in the range of 1 MHz.

Based on received signals on the five channels from the filter bank 20, the idle channel determiner 21 determines an idle channel.

Since the idle channel determiner 21 determines an idle channel according to the above determination rule, and data on the determined idle channel is outputted to the quadrature modulator 23, the wireless apparatus 2 can transmit transmission data using the idle channel.

Since the data on the determined idle channel is also outputted to the frequency transformer 16, the frequency transformer 16 can receive only a signal in the frequency band f3 corresponding to the idle channel. Therefore, it is then possible for the demodulation unit 18 to correctly demodulate a signal on the determined idle channel.

In the wireless apparatus 3, the control unit 31 controls the switch SW2 to connect the antenna ANT2 and the LNA 32 to enable reception of the wireless signal S3.

For example, when a range from 920 MHz to 921 MHz is used as one block and five channels are set in the block, the frequency transformer 36 transforms a frequency of a signal in a range of 1 MHz into the frequency of a baseband signal, and the block-width LPF 39 passes only a signal in the range of 1 MHz.

Based on received signals on the five channels from the filter bank 40, the idle channel determiner 41 determines an idle channel.

Since the idle channel determiner 41 has the same rule as the idle channel determiner 21 as described above, the same channel as the idle channel determiner 21 is determined as an idle channel.

Since the idle channel determiner 41 outputs data on the determined idle channel to the frequency transformer 36, the frequency transformer 36 receives only a signal in the frequency band f3 corresponding to the idle channel. As a result, the demodulation unit 38 can correctly demodulate a signal on the determined idle channel.

Since the data on the determined idle channel is also outputted to the quadrature modulator 43, also the wireless apparatus 3 can then transmit a signal using the idle channel.

As described above, since the wireless apparatus 3 confirms reception of the predetermined signal in the signal confirmation unit 42, the demodulation unit 38 can demodulate only a signal confirmed in the signal confirmation unit 42, and execute the predetermined process.

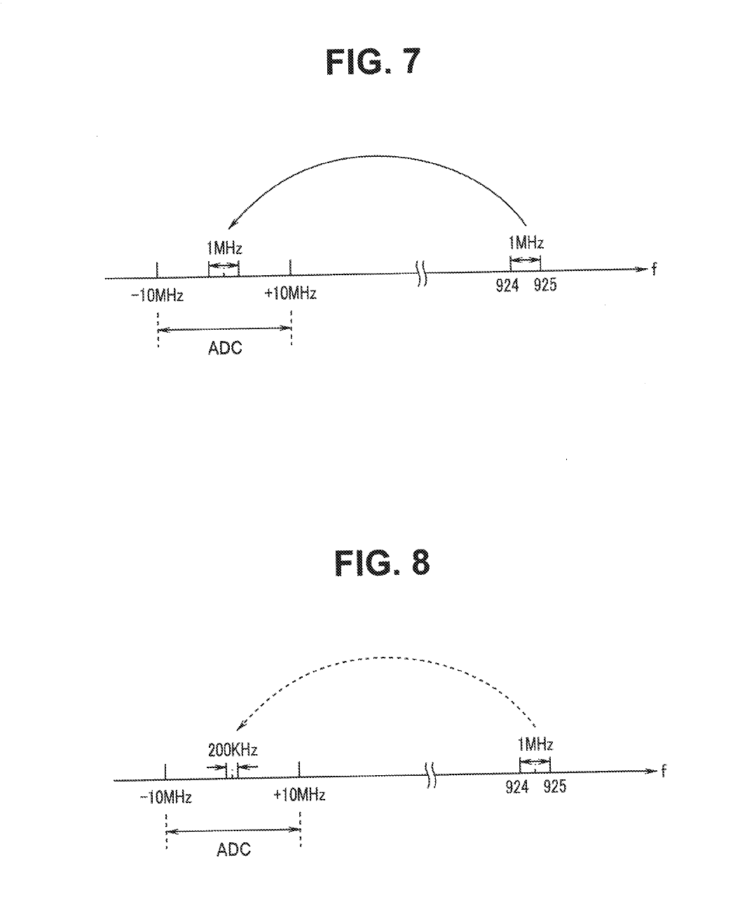

FIG. 7 is a diagram showing a frequency band in carrier sensing in the wireless apparatuses 2 and 3. As shown in FIG. 7, when carrier sensing is executed, a signal in a wide range corresponding to a block width is outputted to the block-width LPF 19 or 39.

Here, a case is shown as an example where a band of a block including five frequencies is 1 MHz, and a frequency between 924 MHz and 925 MHz is received, for example. A band of the ADC 35 is wider than a width of 1 MHz. As shown in FIG. 7 by a solid arrow, in carrier sensing, the frequency transformers 16 and 36 transform a signal with a frequency corresponding to a band with a width of 1 MHz into the frequency of a baseband signal for output.

Since the wireless signal S3 is a continuous wave, and phase detection or the like is performed when the wireless signal S3 is demodulated in the wireless apparatus 3 on the reception side, the wireless signal S3 is transformed into a baseband signal with a channel width to be used.

FIG. 8 is a diagram showing a frequency band in signal demodulation in the wireless apparatuses 2 and 3. As shown in FIG. 8, when a frequency of an idle channel is determined in the idle channel determiners 21 and 41, the frequency transformers 16 and 36 transform a signal with a width of 200 KHz into a baseband signal at 0 (zero) Hz for output as shown by a dotted arrow so as to receive only a signal corresponding to the frequency of the determined channel.

Therefore, in the wireless apparatuses 2 and 3, the frequency band is broadened in carrier sensing, and the frequency band is narrowed in receiving and demodulating a signal, so that only a signal on the idle channel is transformed into a baseband signal.

Note that although the wireless apparatus 2 is a transmission apparatus and the wireless apparatus 3 is a reception apparatus in the above example, the wireless apparatus 3 may be a transmission apparatus and the wireless apparatus 2 may be a reception apparatus because the wireless apparatus 3 has the same configuration as the wireless apparatus 2.

As described above, according to the above embodiment, it is possible to provide a wireless system and a wireless apparatus capable of rapidly determining an idle channel using carrier sensing.

The above wireless system 1 is applicable to a system such that one of the wireless apparatuses is portable, and a distance between the wireless apparatuses 2 and 3 is variable.

For example, the above wireless system 1 is also applicable to a smart key system between a vehicle and a key. In the wireless system, the vehicle has the wireless apparatus 2, and the key being a portable apparatus possessed by a driver of a car has the wireless apparatus 3. The wireless signal S1 is always or regularly transmitted from the vehicle as a beacon, and the key on the reception side responds to the wireless signal S1 to transmit the wireless signal S2 to the vehicle.

A plurality of channels are set for communication between the vehicle and the key. When the wireless apparatus 3 enters a radius with a predetermined distance of the wireless apparatus 2, the wireless apparatuses 2 and 3 receive a trigger signal to execute carrier sensing on the plurality of channels simultaneously to determine an idle channel. As a result, it is possible to realize a smart key system in which rapid transmission/reception of the wireless signal S3 is performed.

Next, modifications of the above embodiment will be described.

### (Modification 1)

Although a plurality of channels, which are five channels in the above example, are set in one block in the above embodiment, it is possible to set a plurality of blocks, and when no idle channel exists in one block in which carrier sensing has been performed, to perform carrier sensing on another block to check and determine an idle channel.

For example, as a frequency band of the wireless signal S3, a range from 924 MHz to 934 MHz is divided into ten blocks at an interval of 1 MHz, and five center frequencies fc are set in each divided block at an interval of 200 KHz.

Although the wireless apparatuses 2 and 3 use a wireless signal with one center frequency fc selected from within the selected block for communication, it is checked whether an idle channel exists or not in one certain block in carrier sensing, and when the block has no idle channel, carrier sensing is performed for another block.

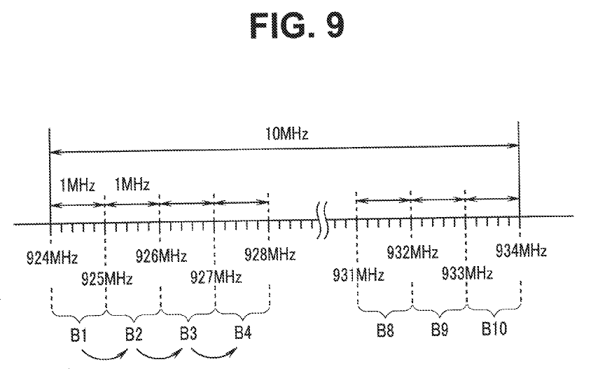

FIG. 9 is a diagram for explaining a determination rule in carrier sensing in each of the wireless apparatuses 2 and 3 when a plurality of blocks each having a plurality of channels exist.

For example, in the determination rule, as shown in FIG. 9, at first, carrier sensing is performed for five channels in one block B1 having a lowest frequency band between 924 MHz and 934 MHz. When the five channels in the block B are all in the busy state, next, carrier sensing is performed for five channels in a block B2 having a lowest frequency band next to the block B1. When the five channels in the block B2 are all in the busy state, next, carrier sensing is performed for five channels in a block B3 having a lowest frequency band next to the block B2.

In such a manner described above, when carrier sensing is started from the block B1, and five channels in all blocks of the blocks B1-B9 are all in the busy state, finally, carrier sensing is performed for five channels in a block B10 having a highest frequency band between 924 MHz and 934 MHz, thus performing carrier sensing on each block in a predetermined order. When the five channels in the last block B10 are also in the busy state, returning to the block B1, similar carrier sensing is repeated.

Also the determination rule in FIG. 9 should just be the same as the wireless apparatus 2 and 3, or may be a rule other than the rule shown in FIG. 9.

### (Modification 2)

Although each of the demodulation units 18 and 38 has the signal confirmation unit 28 or 48 in the wireless apparatus 2 or 3 in the above embodiment, when one is a transmission apparatus and the other is reception apparatus, it suffices to provide a signal confirmation unit only for the wireless apparatus on the reception side.

For example, in the above example, when the wireless apparatus 2 performs only transmission of signals, the signal confirmation unit 28 of the wireless apparatus 2 is unnecessary.

### (Modification 3)

Although carrier sensing is performed in both the wireless apparatuses 2 and 3 in the above embodiment, only the wireless apparatus 2 may perform carrier sensing to determine an idle channel, and use a signal in the frequency band of the wireless signal S1 or S2 to communicate information on the determined idle channel to the wireless apparatus 3.

In the case, the control unit 31 of the wireless apparatus 3 controls the frequency transformer 36 to receive the wireless signal S3 based on information on the determined idle channel from the wireless apparatus 2.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless system including a first wireless apparatus and a second wireless apparatus, wherein
the first wireless apparatus includes:
a first reception circuit
configured to receive a signal in a predetermined frequency band;
a first carrier sensing circuit configured to perform first carrier sensing in which, in response to reception of a first signal, signals on a plurality of channels included in the predetermined frequency band received in the first reception circuit are simultaneously received and use states of the respective channels are detected based on the received signals on the respective channels; and
a first idle channel determiner configured to determine an idle channel from the plurality of channels based on the use states of the respective channels detected in the first carrier sensing circuit according to a predetermined determination rule,
and the second wireless apparatus includes:
a second reception circuit configured to receive a signal in the predetermined frequency band;
a second carrier sensing circuit configured to perform second carrier sensing in which, in response to reception of a second signal, signals on the plurality of channels included in the predetermined frequency band received in the second reception circuit are simultaneously received and the use states of the respective channels are detected based on the received signals on the respective channels; and
a second idle channel determiner configured to determine the idle channel from the plurality of channels based on the use states of the respective channels detected in the second carrier sensing circuit according to a same determination rule as the predetermined determination rule.

2. The wireless system according to claim 1, wherein:
the first wireless apparatus includes a transmission circuit configured to transmit a third signal to be transmitted using the idle channel determined in the first idle channel determiner; and
the second wireless apparatus receives the third signal in the second reception circuit using the idle channel determined in the second idle channel determiner.

3. The wireless system according to claim 2, wherein
the second reception circuit receives the third signal by performing demodulation and transformation into a baseband signal using a signal in a frequency band of the idle channel.

4. The wireless system according to claim 1, wherein:
the first wireless apparatus includes a first transmission circuit configured to transmit a third signal to be transmitted using the idle channel determined in the first idle channel determiner;
the second wireless apparatus includes a second transmission circuit configured to transmit a fourth signal to be transmitted using the idle channel determined in the second idle channel determiner;
the first wireless apparatus receives the fourth signal in the first reception circuit using the idle channel determined in the first idle channel determiner; and
the second wireless apparatus receives the third signal in the second reception circuit using the idle channel determined in the second idle channel determiner.

5. The wireless system according to claim 4, wherein:
the first reception circuit receives the fourth signal by performing demodulation and transformation into a baseband signal using a signal in a frequency band of the idle channel; and
the second reception circuit receives the third signal by performing demodulation and transformation into a baseband signal using a signal in a frequency band of the idle channel.

6. The wireless system according to claim 1, wherein
the first signal is a response signal to reception of the second signal.

7. The wireless system according to claim 6, wherein
the first signal and the second signal are signals in a frequency band different from the predetermined frequency band.

8. The wireless system according to claim 7, wherein
the first signal and the second signal are signals in frequency bands different from each other.

9. The wireless system according to claim 7, wherein
the first signal and the second signal are signals in a frequency band in which carrier sensing is not legally required.

10. A wireless apparatus including:
a reception circuit configured to receive a signal in a predetermined frequency band;
a carrier sensing circuit configured to perform carrier sensing in which, in response to reception of a first signal, signals on a plurality of channels included in the predetermined frequency band received in the reception circuit are simultaneously received and use states of the respective channels are detected based on the signals on the respective channels; and
an idle channel determiner configured to determine an idle channel for transmitting or receiving a second signal based on the use states of the respective channels detected in the carrier sensing circuit according to a predetermined determination rule.

11. A wireless apparatus including:
a reception circuit configured to receive a signal in a predetermined frequency band;
a carrier sensing circuit configured to perform carrier sensing in which, in response to reception of a predetermined signal, signals on a plurality of channels included in the predetermined frequency band received in the reception circuit are simultaneously received and use states of the respective channels are detected based on the signals on the respective channels;
an idle channel determiner configured to determine an idle channel for transmitting or receiving a second signal based on the use states of the respective channels detected in the carrier sensing circuit according to a predetermined determination rule; and
a transmission circuit configured to transmit the second signal to be transmitted using the idle channel determined in the idle channel determiner.

12. The wireless apparatus according to claim 11, wherein
the reception circuit receives the second signal by performing demodulation and transformation into a baseband signal using a signal in a frequency band of the idle channel.

13. The wireless apparatus according to claim 11, wherein
the predetermined signal is a signal in a frequency band different from the predetermined frequency band.

14. The wireless apparatus according to claim 11, wherein
the predetermined signal is a signal in a frequency band in which carrier sensing is not legally required.
